(19) United States
(12) Patent Application Publication
(10) Pub. No.: US 2023/0130405 A1
(43) Pub. Date: Apr. 27, 2023

(54) LIGHTING DEVICE

(71) Applicant: TOYODA GOSEI CO., LTD., Kiyosu-shi (JP)

(72) Inventors: Kanae MATSUMURA, Kiyosu-shi (JP); Yasutsugu SUGIURA, Kiyosu-shi (JP); Kenichi ITO, Kiyosu-shi (JP); Hirotaka HORI, Kiyosu-shi (JP)

(21) Appl. No.: 17/964,443

(22) Filed: Oct. 12, 2022

(30) Foreign Application Priority Data
Oct. 27, 2021 (JP) 2021-175269

(51) Int. Cl. B60Q 3/14; B60K 37/02

(52) U.S. Cl. CPC B60Q 3/14; B60K 37/02

(57) ABSTRACT

A lighting device to be installed in an instrument panel inside a vehicle to be used as an indirect lighting device to emit a light reflected on a surface of the instrument panel. The lighting device is installed at a space behind the instrument panel while being separated from a gap to serve as a light extraction slot of the instrument panel.

### CROSS-REFERENCES TO RELATED APPLICATION

The present application claims the priority of Japanese patent application No. 2021/175269 filed on Oct. 27, 2021, and the entire contents of Japanese patent application No. 2021/175269 are hereby incorporated by reference.

### TECHNICAL FIELD

The present invention relates to a lighting device used inside a vehicle.

### BACKGROUND ART

A lighting device is known which is installed on an instrument panel inside a vehicle and used as indirect lighting (see e.g., Patent Literature 1). The lighting device is installed in such a way as to be embedded in a designed surface of the instrument panel. Light emitted from the lighting device reflects at a lower step surface of the instrument panel.

### CITATION LIST

### Patent Literature

Patent Literature 1: JP 2009/184668 A

### SUMMARY OF INVENTION

The lighting device of Patent Literature 1 is installed in such a way as to be embedded in the designed surface of the instrumental panel and, therefore, the only thing that can be easily done in order to adjust the light emission direction is to change the installation position along the designed surface of the instrument panel. Thus, the light emission direction depends on the outline of the designed surface of the instrument panel and, therefore, there are more restrictions on the design of the instrument panel.

It is an object of the invention to provide a lighting device which can easily set its light emission direction even when being installed in the instrument panel inside the vehicle to be used as an indirect lighting device.

According to an aspect of the invention, a lighting device defined in (1) to (5) below is provided.

(1) A lighting device to be installed in an instrument panel inside a vehicle to be used as an indirect lighting device to emit a light reflected on a surface of the instrument panel,
wherein the lighting device is installed at a space behind the instrument panel while being separated from a gap to serve as a light extraction slot of the instrument panel.

(2) The lighting device according to (1), further comprising a first fixing part to fix the lighting device to an upper part of the instrument panel higher than the gap, and a second fixing part to fix the lighting device to a lower part of the instrument panel lower than the gap.

(3) The lighting device according to (1) or (2), wherein the lighting device is not less than 10 mm separated from the gap.

(4) The lighting device according to any one of (1) to (3), wherein the reflected surface of the instrument panel comprises an irradiated area and a width of the irradiated area in a depth direction is not less than 10 mm.

(5) The lighting device according to any one of (1) to (4), wherein the instrument panel comprises a lower panel above the gap and the lighting device comprises a prism to direct the light emitted from the lighting device to be reflected on a surface of the lower panel.

### Advantageous Effects of Invention

According to an embodiment of the present invention, a lighting device can be provided which can easily set its light emission direction even when being installed in the instrument panel inside the vehicle to be used as an indirect lighting device.

### BRIEF DESCRIPTION OF DRAWINGS

FIG. 1 is a schematic view showing a vehicle interior around an instrument panel to show an arrangement position of lighting device according to the embodiment of the present invention.

FIGS. 2A, 2B are longitudinal cross-section views showing the instrument panel providing the lighting device according to the embodiment of the present invention.

FIG. 3 is an exploded perspective view showing a structure of the lighting device according to the embodiment of the present invention.

FIG. 4 is a graph chart showing a relation between a width W of irradiated area in a depth direction and perceived brightness.

### DESCRIPTION OF EMBODIMENTS

### Embodiments

A lighting device 1 according to an embodiment of the present invention is arranged in an instrument panel inside a vehicle and used as an indirect lighting that irradiating light to reflect on a surface of the instrument panel. Hereinafter, an embodiment serving as the indirect lighting by reflecting light at a lower panel that is a part of the instrument panel will be explained as a typical example of the embodiment of the present invention.

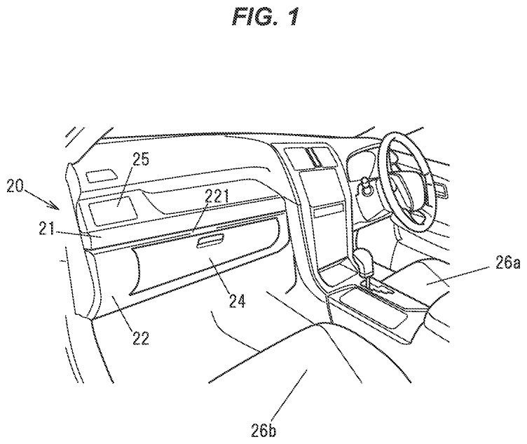

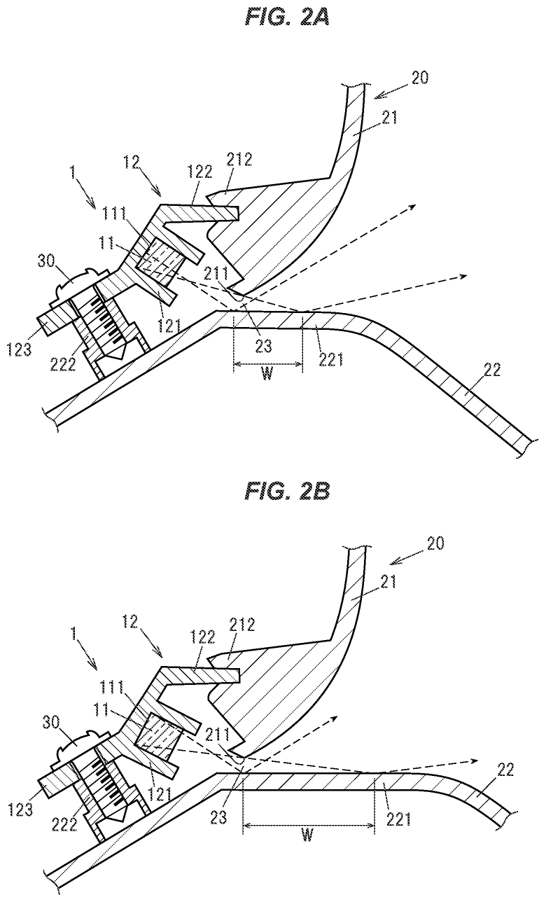

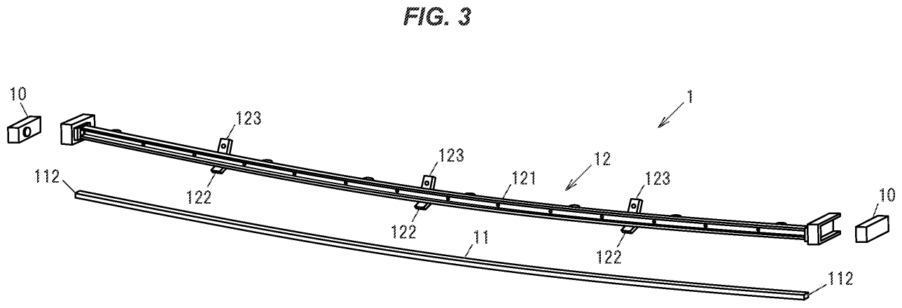

FIG. 1 is a schematic view showing a vehicle interior around the instrument panel 20 to show an arrangement position of the lighting device 1. FIGS. 2A, 2B are longitudinal cross-section views showing the instrument panel 20 providing the lighting device 1. FIG. 3 is an exploded perspective view showing a structure of the lighting device 1.

The instrument panel 20 is a vehicle interior parts arranged in front of seat 26 (driver's seat 26a, passenger's seat 26b), in which vehicle instruments, a vent of air conditioner etc., is arranged. The instrument panel 20 comprises an upper panel 21 configuring an upper part of that and a lower panel 22 configuring a lower part of that. For example, a glove box 24 etc., is provided in the lower panel 22 in front of the passenger's seat, and a vent 25 of air conditioner etc., is provided at the upper panel 21.

As shown in FIGS. 2A, 2B, a gap 23 serving as a light extraction slot extracting light emitted from the lighting device 1 is provided between the upper panel 21 of the instrument panel 20 and the lower panel 22 arranged below the upper panel 21. That is, the upper panel 21 corresponds to an upper part of the instrument panel 20 higher than the gap 23, and the lower panel 22 corresponds to a lower part of the instrument panel 20 lower than the gap 23. An upper side edge of the gap 23 is formed from an edge 211 of the upper panel 21. A lower side edge of the gap 23 is formed from an upper surface 221 of the lower panel 22.

The lighting device 1 is installed in a space behind the instrument panel 20 (an invisible space from occupant opposite to a designed surface). Light emitted from the lighting device 1 passes through the gap 23, reflects at the upper surface 221 of the lower panel 22 that configures a lower edge of the gap 23. Then the reflected light is visualized to occupant sit on the seat 26 as indirect light.

Light reflected at the upper surface 221 of the lower panel 22 advances upward obliquely toward a space at height where a head of occupant sits on the seat 26 is located. Therefore, light can be visible when the occupant sitting on the seat 26 lowers eyes from frontside, for example, when the driver lowers eyes to see a smartphone in hand during vehicle stopped at red light.

Therefore, for example, it is possible to notify a vehicle ahead starting even when the occupant does not face frontside in vehicle stopping by using the indirect lighting reflected at the upper surface 221 of the lower panel 22 as notice of starting the vehicle ahead. More specifically, for example, with combining notice of the vehicle ahead by using sound, it is possible to notify by the indirect lighting from the lighting device 1 immediately after detecting the vehicle ahead starting and notify by sound when distance between the vehicle riding and the vehicle ahead becomes the predetermined distance (e.g., 4 m).

The lighting device 1 comprises a light emitting device 10 as a light source, a rod-shaped light guiding body 11 that receives light emitted from the light emitting device 10, propagates inside the light guiding body 11, and radiates the light, and a housing 12 housing the light guiding body 11 to fix the light emitting device 10 at both ends of the light guiding body 11. The lighting device 1 is attached at the space behind the instrument panel 20 such that a longitudinal direction of the light guiding body 11 is aligned with a longitudinal direction of the gap 23 (vehicle width direction).

The light emitting device 10 includes light emitting elements such as light emitting diode (LED). For example, the light emitting element included in the light emitting device 10 is an LED called the full color LED in which three colored (red, green, blue) LED is packed. In this case, it is possible to emit predetermined colored light by pulse width modulation (PWM) control etc., by an in-vehicle Electric Control Unit (ECU) through in-vehicle network.

The light guiding body 11 is formed of materials that can penetrate light emitted from the light emitting device 10 such as clear acrylic material. In addition, the light guiding body 11 comprises a prism 111 to reflect light propagated inside the light guiding body 11 and radiate toward outside. The prism 111 is provided along a length direction of the rod-shaped light guiding body 11.

For example, the prism 111 is configured from a group of linear grooves that is arranged on a plane facing the gap 23 and is respectively extended along a direction orthogonal to the length direction of the light guiding body 11. The group of linear grooves forming the prism 111 is e.g., a linear groove having a V-shaped cross-section. In addition, the prism 111 may be formed from a group of linear projections instead of the group of linear grooves. In this case, for example, the linear projection has a triangle cross-section.

The light guiding body 11 is a rod-shaped light guiding body having polygon or circular cross-section orthogonal to the length direction with providing a prism 111. In examples shown in FIGS. 2A, 2B. the cross-section orthogonal to the length direction of the light guiding body 11 is a square. In the meantime, the light guiding body 11 may be curved along a surface shape of the instrument panel 20.

In the structure shown in FIG. 3, both end surfaces 112 of the light guiding body 11 become a light receiving surface. Light emitted from the light emitting device 10 enters from both end surfaces 112 into the light guiding body 11 and propagates in the length direction of the light guiding body 11. Light propagating inside the light guiding body 11 reflects at the prism 111 and then radiates from the light guiding body 11 towards the gap 23.

The housing 12 is formed of materials such as Potassium Competitive Acid Blockers (PCABs) colored in black or while that does not penetrate light emitted from the light emitting device 10.

The lighting device 1 is installed at the space behind the instrument panel 20 with separated from the gap 23. Since the lighting device 1 is installed with separated from the gap 23, it is possible to freely set position or angle of the lighting device 1, i.e., position or angle of the light guiding body 11. In the meantime, it is preferable to set distance between the lighting device 1 and the gap 23 at not more than 10 mm to increase variance in setting position or angle of the lighting device 1.

Then, as shown in FIGS. 2A, 2B, by adjusting position or angle of the lighting device 1, it is possible to adjust width W in a depth direction (a direction orthogonal to the length direction of the gap 23) at an area irradiated by the lighting device 1 in the upper surface 221 of the lower panel 22 (hereinafter, it is defined as “irradiated area”). In examples shown in FIGS. 2A, 2B, since angle of the prism 111 of the light guiding body 11 in the lighting device 1 shown in FIG. 2A is closer to the vertical direction than that of the lighting device 1 shown in FIG. 2B, light emitted from the light guiding body 11 becomes close to a horizontal direction and thus the width W of the irradiated area widen.

For example, the width W of the irradiated area can be freely adjusted between 10 and 40 mm. If the width W is set at between 10 and 40 mm, it is possible for the occupant to notify lighting even when it is daytime when lighting is not conspicuous compared to nighttime, and/or the occupant does not eye the irradiated area, e.g., when the occupant looks down a display of smartphone. Thus, it is possible to use indirect lighting by the lighting device 1 for informing warning to the occupant or heading up. In the meantime, indirect lighting thus far used inside a vehicle is lighting that is blended into surroundings commonly called as the ambient illumination and is not conspicuous. Thus, it is impossible to use for informing.

When using indirect lighting by the lighting device 1 for informing, light emission color of the light emitting device 10 (light emission color of the lighting device 1) is preferable to be high visible color such as while or clear blue (blueish white) when color of the upper surface 221 of the lower panel 22 is black.

Lighting intensity of the lighting device 1 is set corresponding to the width W of the irradiated area on the upper surface 221 of the lower panel 22. For example, when using indirect lighting for informing as described above, the lighting intensity is set such that brightness at center of the irradiated area is respectively set at 18 to 50 cd/mm², 12 to 30 cd/mm², and 4 to 30 cd/mm² when the width W is set at 10, 20, and 40 mm.

In addition, the lighting device 1 can be used as ambient illumination by reducing the lighting intensity, e.g., by setting the lighting intensity in one-fifth to one-tenth of the lighting intensity used for informing. That is, the lighting device 1 can be used for both of informing and ambient illumination.

In the meantime, when setting the width W of the irradiated area at somewhat large, as shown in FIG. 2B, it may be set a width of the upper surface 221 of the lower panel 22 in a width W direction compared to setting the width W small.

In addition, as the lighting device 1 is fixed to the instrument panel 20, it is preferable to be fixed to both upper panel 21 and lower panel 22. Since the lighting device 1 is installed being separated from the gap 23, it is important to locate the lighting device 1 against the gap 23 to precisely pass light in the gap 23. It is possible to more precisely locate the lighting device 1 by fixing the lighting device 1 to both upper panel 21 and lower panel 22.

Further, it is possible to relatively locate the upper panel 21 and the lower panel 22 by fixing the lighting device 1 to both upper panel 21 and lower panel 22. Hereby, it is possible to precisely setting width (height) of the gap 23.

When the lighting device 1 is fixed to both upper panel 21 and lower panel 22, the housing 12 comprises a first fixing part 122 to fix the housing 12 to the upper panel 21, and a second fixing part 123 to fix the housing 12 to the lower panel 22.

For example, the first fixing part 122 and the second fixing part 123 are projections suitable for a screw fixing or pin fixing that is protrude from a main body 121 of the housing 12 to house the light guiding body 11. Since the lighting device 1 is especially preferable to be tightly fixed to a lower panel 22 side, it is preferable to define the second fixing part 123 as a projection for the screw fixing. In addition, where the screw fixing is used in fixing the second fixing part 123 to the lower panel 22, as shown in FIGS. 2A, 2B, it is useful to adjust the position of the light guiding body 11 since it is possible to separate the position of the light guiding body 11 from the lower panel 22 (guaranteeing height).

In examples shown in FIGS. 2A, 2B, the first fixing part 122 is a projection for the pin fixing. The first fixing part 122 is fixed by inserting into a groove in a fixing part 212 suitable for the pin fixing provided behind the upper panel 21. The second fixing part 123 is a plate shaped projection for screw fixing. The second fixing part 123 comprises a hole to pass through the screw 30. The second fixing part 123 is fixed at a fixing part 222 for the screw fixing provided on the lower panel 22 by the screw 30.

In the meantime, the instrument panel 20 may be a continuous panel along upper and lower that has an opening as the gap 23 and is not separated to the upper panel 21 and the lower panel 22. In this case, an upper side part of the instrument panel 20 higher than the gap 23 is used instead of the upper panel 21 in the embodiment, and a lower side part of the instrument panel 20 lower than the gap 23 is used instead of the lower panel 22 in the embodiment. For example, the above fixing part 212 is provided at the upper side part of instrument panel 20 higher than the gap 23, and the above fixing part 222 is provided at the lower side part of instrument panel 20 lower than the gap 23.

### Effects of Embodiments

The lighting device 1 according to the embodiment of the present invention can easily set the position or the angle of the lighting device 1 since the lighting device 1 is installed at a space behind the instrument panel 20 with separated from the gap 23. Thus, it is possible to easily adjust a lighting direction of light emitted from the lighting device 1 without losing design freedom for the instrument panel 20 and so on. In addition, it is possible to use indirect lighting by the lighting device 1 for informing warning or heading up to the occupant by increasing the width of the irradiated area in a depth direction in a reflection surface for light emitted from the lighting device 1 (e.g., not less than 10 mm).

### EXAMPLES

Test using mock-up reproducing structure of the instrument panel 20 and the lighting device 1 shown in FIGS. 2A, 2B was performed. Relation between the width W of irradiated area in the depth direction on the upper surface 221 of the lower panel 22 and ease for notifying indirect light from the irradiated area was estimated.

In this test, material of the upper surface 221 of the lower panel 22 is set as a black skin, light emission color of the lighting device 1 is set as clear blue, width of the irradiated area in the length direction (length direction of the gap 23) is set at 350 mm, the width W of the irradiated area is set at 10 to 40 mm, brightness of indirect light at a center of the irradiated area is set at 10 to 200 cd/mm², ambient illuminance is set at 3000 lx (assuming cloud day).

Total number of subjects was 12 including men over 50s of 5, men under 40s of 6, women under 30s of 1. In addition, relational position between eyes of subjects and the irradiated area is set to define angle (depression angle) of line of sight when subjects view the irradiated area of 30° to suppose line of sight of occupant sit on the seat 26.

Next, the applicant searched whether subjects notify indirect light when subjects look down a display of smartphone in hand or not. Here, brightness of indirect light at the center of the irradiated area steeply increases from 10 cd/mm². Brightness in which over 50% of subjects (more than 6) can notify the indirect light is defined as “perceived brightness.”

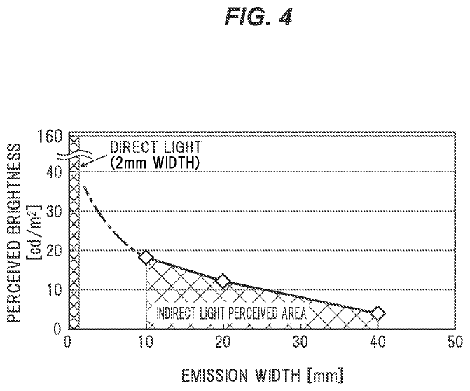

FIG. 4 is a graph chart showing a relation between the width W of the irradiated area in the depth direction and perceived brightness obtained by the test according to the example. FIG. 4 also shows a test result in using direct light in width of 2 mm instead of indirect light as a reference example.

According to FIG. 4, perceived brightness when the width of irradiated area is set at 10 mm, 20 mm, and 40 mm are respectively 18 cd/mm², 12 cd/mm², and 4 cd/mm². It shows that the perceived brightness deceases as the width increases. From these results, the applicant finds that occupant perceived light even though width is 2 mm when using direct light having high lighting intensity. However, the applicant finds that the occupant perceives light when the width is approximately 10 to 40 mm even when using indirect lighting having lighting intensity lower than the direct lighting. That is, the applicant find that the indirect lighting can be used for informing to the occupant.

In addition, as the result of test, all of subjects perceive the indirect light when brightness of indirect light at the center of irradiated area are respectively not less than 50 cd/mm², 30 cd/mm², and 30 cd/mm², as the width of irradiated area is set at 10 mm, 20 mm, and 40 mm. From the result, it is preferable to respectively set the brightness of indirect light at the center of irradiated area at 18 to 50 cd/mm², 12 to 30 cd/mm², and 4 to 30 cd/mm² when the width W of the irradiated area are 10 mm, 20 mm, and 40 mm since excessive brightness may be annoy.

In addition, it is preferable to set the brightness of indirect light at the center of irradiated area at 18 to 30 cd/mm² when the width W of the irradiated area is set at 10 to 40 mm. And it is preferable to set the brightness of indirect light at the center of irradiated area as 12 to 30 cd/mm² when the width W of the irradiated area is set at 20 to 40 mm.

Although the embodiments of the invention have been described, the invention is not to be limited to the embodiments. The various kinds of modifications can be implemented without departing from the gist of the invention. In addition, the constituent elements in the embodiments and examples can be arbitrarily combined without departing from the gist of the invention.

In addition, the invention according to claims is not to be limited to the above embodiments and examples. Please note that all combinations of the features described in the embodiments are not necessary to solve the problem of the invention.

### REFERENCE SIGNS LIST

1 LIGHTING DEVICE
10 LIGHT EMITTING DEVICE
11 LIGHT GUIDING BODY
111 PRISM
12 HOUSING
122 FIRST FIXING PART
123 SECOND FIXING PART
20 INSTRUMENT PANEL
21 UPPER PANEL
22 LOWER PANEL
221 UPPER SURFACE
23 GAP

1. A lighting device to be installed in an instrument panel inside a vehicle to be used as an indirect lighting device to emit a light reflected on a surface of the instrument panel,
wherein the lighting device is installed at a space behind the instrument panel while being separated from a gap to serve as a light extraction slot of the instrument panel.

2. The lighting device according to claim 1, further comprising a first fixing part to fix the lighting device to an upper part of the instrument panel higher than the gap, and a second fixing part to fix the lighting device to a lower part of the instrument panel lower than the gap.

3. The lighting device according to claim 1, wherein the lighting device is not less than 10 mm separated from the gap.

4. The lighting device according to claim 1, wherein the reflected surface of the instrument panel comprises an irradiated area and a width of the irradiated area in a depth direction is not less than 10 mm.

5. The lighting device according to claim 1, wherein the instrument panel comprises a lower panel above the gap and the lighting device comprises a prism to direct the light emitted from the lighting device to be reflected on a surface of the lower panel.
